(19) United States
(12) Patent Application Publication
(10) Pub. No.: US 2014/0113149 A1
(43) Pub. Date: Apr. 24, 2014

(54) SHAPE MEMORY POLYMER ARTICLE

(71) Applicant: GM GLOBAL TECHNOLOGY OPERATIONS LLC, Detroit, MI (US)

(72) Inventors: Alan L. Browne, Grosse Pointe, MI (US); Nancy L. Johnson, Northville, MI (US); William B. Carter, Calabasas, CA (US); Geoffrey P. McKnight, Los Angeles, CA (US)

(73) Assignee: GM GLOBAL TECHNOLOGY OPERATIONS LLC, Detroit, MI (US)

(21) Appl. No.: 13/655,915

(22) Filed: Oct. 19, 2012

(51) Int. Cl. B29C 43/52; B32B 27/00

(52) U.S. Cl. 428/457; 264/241

(57) ABSTRACT

An adjustable shape memory hold article, and method of adjusting same, are disclosed, where the includes a plurality of shape memory polymer segments having different activation temperatures or a shape memory polymer having a differential between T_{S} and T_{F} of at least 10° C. and no more than 70° C.

### FIELD OF THE INVENTION

Exemplary embodiments of the invention are related to adjustable shape memory articles and, more specifically, to adjustable shape memory articles thermally activated during reconfiguration and/or repositioning.

### BACKGROUND

Shape memory articles have been used and proposed for use in a wide variety of applications, including but not limited to furniture, receptacles, retention devices, medical devices. Such articles often are fabricated from or contain a segment or component comprising a shape memory polymer (SMP) or a shape memory alloy (SMA). In many cases, it is desirable for the shape memory article to utilize its shape memory capability to conform its shape to the shape or position of another object or article.

Shape memory polymers, including shape memory polymer foams, have been used to make conforming shape memory articles where the SMP is heated to a low-modulus state, deformed, and then cooled to a high-modulus state to retain the deformation. In order to produce a desired level of deformation in articles formed from shape memory polymers, it has often been necessary or desirable to subject the shape memory polymer to a controlled level of deformation to achieve a target shape or position. In cases where it is necessary or desirable to, at different times, subject the shape memory polymer to multiple or different levels of deformation, complex, expensive, and/or difficult to maintain actuating device mechanisms may be required in order to provide the different levels of deformation.

In view of the above, many alternatives have been used over the years to provide deformable shape memory articles; however, new and different alternatives are always well received that might be more appropriate for or function better in certain environments, provide a more precise adjustment or could be less costly or more durable.

### SUMMARY OF THE INVENTION

In one exemplary embodiment, there is a method of adjusting the shape of a shape memory article comprising a plurality of shape memory polymer segments having different activation temperatures. This method comprises heating the article to a temperature greater than the activation temperature of at least one of the plurality of shape memory polymer segments and less than the activation temperature of at least one other of the plurality of shape memory polymer segments, applying a compressive force to deform the heated shape memory polymer to a desired level of deformation and cooling the article to set the shape memory polymer at the desired level of deformation. In a more specific embodiment, a first shape memory polymer segment has a lowest activation temperature of the plurality of shape memory polymer segments, and each successive adjacent shape segment has a progressively higher activation temperature.

In another exemplary embodiment, there is a method of adjusting the shape of a shape memory article comprising a shape memory polymer having a differential between T_{S} and T_{F} of at least 10° C. and no more than 70° C. The method comprises heating the shape memory polymer to an activation temperature T_{S} and continuing to heat the shape memory polymer, thereby progressively raising the temperature in the range of T_{S} and T_{F} and progressively reducing the stiffness of the shape memory polymer over a period of time, while applying compressive force to deform the heated shape memory polymer to a desired level of deformation.

In another exemplary embodiment, a controllably deformable shape memory article comprises a first shape memory element having a shape memory polymer disposed between and directly or indirectly connected to a first mounting member and second mounting member. The first and second mounting members are movable with respect to one another along a directional path extending between the first and second mounting members through the first shape memory element. At least one second shape memory element comprising a shape memory alloy (SMA) having first and second remembered shapes or lengths activated by temperature change is disposed between and directly or indirectly connected to the first and second mounting members.

In an additional exemplary embodiment, a controllably deformable shape memory article comprises a first shape memory element having a plurality of shape memory polymer segments having different activation temperatures. The first shape memory element is disposed between and directly or indirectly connected to a first mounting member and second mounting member. The first and second mounting members are movable with respect to one another along a directional path extending between the first and second mounting members through the first shape memory element. A load member provides a force urging the first and second mounting members toward each other.

The above features and advantages, and other features and advantages of the invention are readily apparent from the following detailed description of the invention when taken in connection with the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 depicts an exemplary shape memory article comprising a first shape memory element comprised of a plurality of shape memory polymer segments and a load capable of providing a force;

FIG. 2 depicts an exemplary shape memory article comprising a plurality of shape memory polymer segments, SMA members and elastically deformable member;

FIG. 3 is a graphic depiction of shape memory polymer stiffness (E) versus temperature (T);

FIG. 4 depicts a controllably deformable shape memory article comprising a shape memory polymer having a differential between T_{S}→T_{F} of at least 10° C. and no more than 70° C. and a load capable of providing a force; and

FIG. 5 depicts a controllably deformable shape memory article and a shape memory alloy having remembered lengths or shapes and an elastically deformable member.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

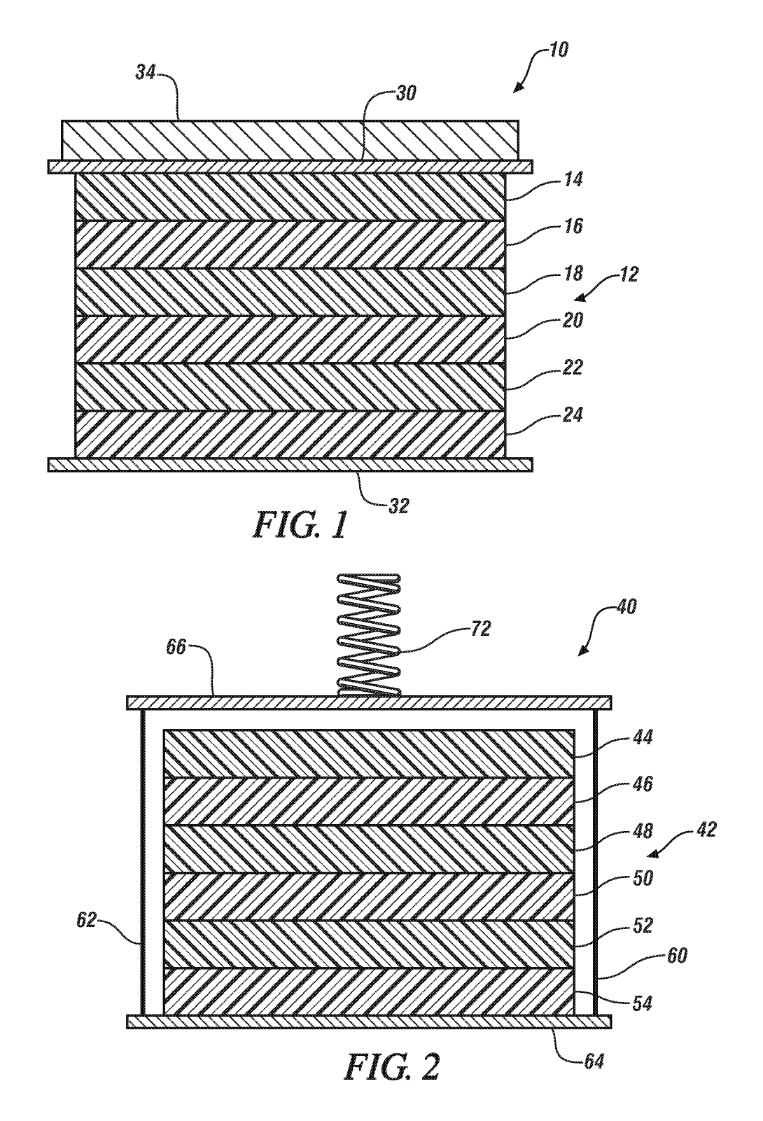

Turning now to the Figures, FIG. 1 depicts an exemplary embodiment of a controllably deformable shape memory article that can be used according to the methods described herein. FIG. 1 shows a cross-section view of a shape memory article 10 comprising a plurality of shape memory polymer segments 14, 16, 18, 20, 22, and 24 having different activation temperatures disposed between and directly or indirectly connected to a first mounting member 30 and a second mounting member 32. Shape memory polymers are known in the art to include both “hard” and “soft” segments. As used herein, activation temperature of a shape memory polymer means the T_{g} (glass transition temperature) of the “soft” segment, which is lower than the Tₘ (melt/molding temperature) of the “hard” segment. One or both of the first and second mounting members 30, 32 are movable with respect to one another along a directional path extending between the first and second mounting members 30, 32. A load member 34 provides force urging the first and second mounting members 30, 32 towards each other.

An exemplary method of adjusting the shape of the shape memory article 10 comprises heating to a temperature greater than the activation temperature of at least one of the plurality of shape memory polymer segments 14, 16, 18, 20, 22, or 24 and less than the activation temperature of at least one other of the plurality of shape memory segments 14, 16, 18, 20, 22, or 24. Heating above the transition temperature of at least one of the segments 14, 16, 18, 20, 22, 24 reduces the modulus of the activated segment such that it can be deformed by compressive force. The method further comprises applying a compressive force to deform the article 10 to a desired level of deformation and cooling to set the activated segment(s) at the desired level of deformation. After cooling, the compressive force is not needed unless and until it is desired to modify the deformation of the article 10. Accordingly, in an additional embodiment, the method comprises removing the compressive force after setting the activated SMP segment(s) at the desired level of deformation. The article may be maintained in its formed shape as shown in FIG. 1 (or a previous formed shape) until it is desired to change the article into a new shape, at which time the temperature and/or force is changed to alter the modulus of at least one of the shape memory polymer segments, thereby rendering the article 10 more deformable.

In an exemplary embodiment, the lowest activation temperature shape memory polymer is segment 14, adjacent to mounting member 30, and each successive segment positioned in the direction towards mounting member 32 has progressively higher activation temperature shape memory polymers. However, the plurality of SMP segments 14, 16, 18, 20, 22, 24 may be arranged provide a targeted location/timing profile of deformation by the selective placement of the lowest transition temperature SMP segment(s) near the surface, middle or in any of a variety of transition temperature ordered sequences to achieve targeted deformation to produce a targeted shape. For example, if the lowest transition temperature SMP segment is SMP segment 20, if it reaches a temperature just above the transition temperature of SMP segment 20, but less than activation temperature of segments 14, 16, 18, 22, 24, segment 20 deforms while segments 14, 16, 18 and segments 22, 24 maintain original shape unless or until segments 14, 16, 18, 22, 24 are heated to above each of their activation temperatures. Alternative temperature selection and sequencing of SMP segments 14, 16, 18, 20, 22, 24 will provide a shape memory article 10 having a targeted deformation and shape, with deformation during heating occurring first in the locations of segments with the lower activation temperatures, followed by deformation in locations segments with higher activation temperatures.

In another exemplary embodiment, the method comprises continuing to increase the temperature of the article 10 above the activation temperature of one or more additional shape memory segments while applying compressive force until a predetermined level of deformation is reached. As each shape memory polymer segment reaches activation temperature, the compressive force deforms the activated shape memory polymer segment, causing mounting member 30 to move closer to mounting member 32. This embodiment allows for gradual deformation so that precise levels of deformation can be achieved.

Turning now to FIG. 2, a cross-section view of a shape memory article 40 is shown having a plurality of shape memory polymer segments 44, 46, 48, 50, 52, and 54 having different activation temperatures, disposed between mounting members 64 and 66. One or both of mounting members 64, 66 are movable with respect to one another along a directional path extending between mounting members 64, 66, which extends through the plurality of shape memory segments. Mounting members 64 and 66 are connected together by SMA wire members 60 and 62. SMA wire members 60, 62 are positioned on opposite sides of the plurality of shape polymer segments. Optionally, an elastically deformable member 72 may be secured to one of the mounting members (shown in FIG. 2 attached to the mounting member 66) to provide a biasing force, for example to urge mounting members 64 and 66 toward each other.

An exemplary method of adjusting the shape memory article 40 comprises heating to a temperature greater than the activation temperature of at least one of the plurality of shape memory polymer segments. The method further comprises activating the SMA wire members 60 and 62 to apply compressive force to deform the shape memory article 40 to a desired level of deformation, and cooling the article 40 to set activated segment(s) at the desired level of deformation. As with the article 10 of FIG. 1, the compressive force may then be removed until and unless it is desired to modify the deformation of the article 40.

In an exemplary embodiment, the lowest activation temperature shape memory polymer is segment 44, adjacent to mounting member 64, and each successive segment positioned in the direction towards mounting member 66 has a progressively higher activation temperature. As discussed and shown in FIG. 1, the article 40 shown in FIG. 2 can comprise any of a variety of sequencing SMP segments of different activation temperatures to achieve a desired deformation profile targeting the location and/or timing profile of deformation by the selective placement of the various activation temperature SMP segment near the surface, middle or in any of a variety of activation temperature ordered sequences. In one exemplary embodiment, segment 44 can have the lowest activation temperature with progressively increasing activation temperature SMP segments 46, 48, 50, 52 and 54. In an alternate embodiment, lowest activation temperature can be in the middle segment 48 with any of a variety of combinations of activation temperature sequences.

Heating above the transition temperature of at least one of the segments reduces the modulus of the activated segment(s) such that it can be deformed by compressive force applied by activated SMA wire members 60, 62, which draws mounting members 64, 66 closer together and deforms the shape activated segment(s). The SMA wire members 60, 62 can be activated by ambient heat that is applied to the shape memory polymer, but are more typically activated by resistance heating resulting from electric current being passed through the SMA wire. Cooling will set the adjusted shape of the shape memory article 40. After it is set, the compressive force is typically not needed unless and until it is desired to modify the deformation of the article. Accordingly, in an additional exemplary embodiment, the method comprises removing the compressive force after setting to the desired level of deformation. Maintaining the temperature at or above the SMP activation temperature while cooling SMA wire members 60, 62 will remove the compressive force and restore the shape memory article 40 to its original shape.

Optionally, an elastically deformable member 72, such as a bias spring, may apply a force urging the article 40 towards its original shape. In this exemplary method, the elastically deformable member 72 deforms during the application of compressive force, and provides force urging the article 40 back to its original shape.

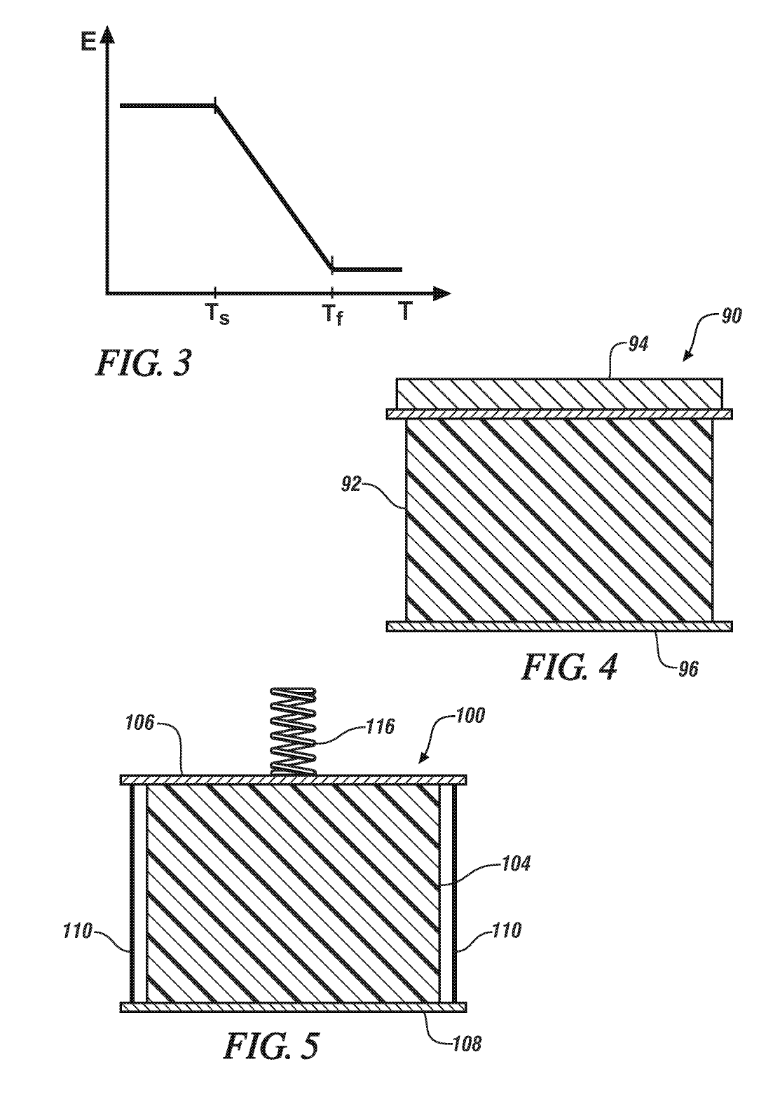

In another exemplary embodiment, the method comprises continuing to increase the temperature of the article 40 above the activation temperature of one or more additional shape memory segments while applying compressive force until a predetermined level of deformation is reached. As each shape memory polymer segment reaches activation temperature, the compressive force deforms the activated shape memory polymer segment(s), causing mounting member 66 to move closer to mounting member 64. This embodiment allows for gradual deformation so that precise levels of deformation can be achieved. As discussed herein, controlled deformation of SMP articles 10, 40 can be achieved by sequentially activating selected segments in a multi-segment article, without complex variable stroke actuator mechanisms. FIG. 3 depicts how the effect of a timed deformation can also be achieved with a mono-material having a broad activation range from T_{S}→T_{F}. In an exemplary embodiment, the differential between T_{S} and T_{F} is at least 10° C. and not more than 70° C.

FIG. 3 depicts the relative change in stiffness, E, of a shape memory polymer in a transition temperature range T_{S}→T_{F}. As used herein, T_{S} is a lower temperature at which the slope of a plot of shape memory polymer stiffness as a function of temperature transitions, as temperature increases, from a relatively flat portion to a portion where stiffness decreases with increasing temperature, and T_{F} is an upper temperature at which the slope of a plot of the stiffness of a shape memory polymer as a function of temperature transitions from the relatively steep portion to a relative flat portion. A sufficiently wide range between T_{S} and T_{F} of, for example, at least 10° C., provides a moderate and controlled rate of the change of stiffness, and thus also of deformation upon heating such that a desired level of deformation can be readily observed and locked in by terminating heating followed by cooling while maintaining load on the article. By controlling temperature within the range of T_{S}→T_{F}, a desired deformation level of SMP can be achieved with accuracy without the use of multiple segments having various activation temperatures. In essence, the broad range of activation temperatures in the range of T_{S}→T_{F} provides multiple activation temperatures for selection to achieve the desired deformation without the need for multiple SMP segments having different activation temperatures.

Shown in FIG. 4 is a shape memory article 90 comprising a shape memory polymer 92 having a differential between T_{S} and T_{F} of at least 10° C. and no more than 70° C. The shape memory polymer 92 is disposed between load member 94 and mounting member 96. In an exemplary embodiment, a method comprises heating the shape memory polymer 92 to an activation temperature T_{S}, and continuing to heat the shape memory polymer 92, thereby progressively raising the temperature in the range between T_{S} and T_{F} and progressively reducing the stiffness of the shape memory polymer 92 over a period of time. As stiffness of the shape memory polymer 92 gets progressively lower, force from the load member 92 deforms the heated shape memory polymer 92 to a desired level of deformation. When the desired level of deformation is reached, the article 90 is cooled to set the shape memory polymer 92 at the desired level of deformation.

By raising the temperature of the shape memory polymer 92 slowly, the shape memory polymer 92 loses stiffness slowly, and thus deforms slowly under the force of the load 94. As the shape memory polymer 92 continues to heat, the modulus further reduces and the load 94 causes compressive further deformation of the shape memory polymer 92. When the deformation of the shape memory polymer 92 reaches the desired level, it is cooled to set the article at the desired level of deformation. Removing the load 94 removes the compressive force and the article 90 can be restored to its original shape by heating the shape memory polymer 92.

In another exemplary embodiment, shown in FIG. 5, a controllably deformable shape memory article 100 comprises a shape memory polymer 104 disposed between and directly or indirectly connected to a first mounting member 106 and second mounting member 108. One or both of the first and second mounting members 106, 108 are movable with respect to one another along a directional path extending between the first and second mounting members 106, 108 through the shape memory polymer 104. Also provided is at least one shape memory alloy wire 110 having a first remembered shape or length activated by temperature change and disposed between and directly or indirectly connected to the first and second mounting members 106, 108. The shape memory alloy wires 110 having first remembered shapes or lengths provide an alternative method of applying compressive force rather than the load 94 in FIG. 4. Optionally, the controllably deformable article 100 can be returned to its original shape, i.e. the shape memory polymer will exhibit shape memory when heated to a temperature of at least T_{F} after the load that had been used to create the deformation is removed. Further optionally, the controllably deformable article 100 may further comprise an elastically deformable member 116 urging the first and second mounting members 106, 108 away from one another to restore the shape memory polymer 104 to its original shape. In this exemplary embodiment, the contractable SMA wires apply compressive force and the elastically deformable member 72 which deforms (stretches) during the application of compressive force, provides force urging the article 100 back to its original shape.

In another exemplary embodiment, a method of using the controllably deformable article 100 is provided. In this embodiment, the shape memory polymer 104 is heated to reduce its modulus and an activation signal is applied to the shape memory alloy wires 110 to cause them to actuate from a longer length to a shorter length. This activation of the SMA wires causes the first and second mounting members 106, 108 to move toward each other and compress the activated shape memory polymer 104. The shape memory polymer 104 is cooled to set the relative positions of the first and second mounting members 106, 108. In another exemplary method, the actuation signal applied to the shape memory alloy wires (in spring form) 110 causes them to actuate from a shorter length to a longer length, allowing mounting members 106, 108 to move away from each other, for example when a compression-deformed shape memory polymer 104 is activated to return toward its original shape. The optional elastically deformable member 116 may reduce the time for the article 100 to return to original shape. Cooling the shape memory polymer 104 sets the relative positions of the first and second mounting members 106, 108 at a targeted level of deformation.

“Shape memory polymer” or “SMP” generally refers to a polymeric material, which exhibits a change in a property, such as an elastic modulus, a shape, a dimension, a shape orientation, or a combination comprising at least one of the foregoing properties upon application of an activation signal. Shape memory polymers may be thermoresponsive (i.e., the change in the property is caused by a thermal activation signal), photoresponsive (i.e., the change in the property is caused by a light-based activation signal), moisture-responsive (i.e., the change in the property is caused by a liquid activation signal such as humidity, water vapor, or water), or a combination comprising at least one of the foregoing.

Generally, SMPs are phase segregated co-polymers comprising at least two different units, which may be described as defining different segments within the SMP, each segment contributing differently to the overall properties of the SMP. As used herein, the term “segment” refers to a block, graft, or sequence of the same or similar monomer or oligomer units, which are copolymerized to form the SMP. Each segment may be crystalline or amorphous and will have a corresponding melting point or glass transition temperature (Tg), respectively. The term “thermal transition temperature” is used herein for convenience to generically refer to either a Tg or a melting point depending on whether the segment is an amorphous segment or a crystalline segment. For SMPs comprising (n) segments, the SMP is said to have a hard segment and (n−1) soft segments, wherein the hard segment has a higher thermal transition temperature than any soft segment. Thus, the SMP has (n) thermal transition temperatures. The thermal transition temperature of the hard segment is termed the “last transition temperature”, and the lowest thermal transition temperature of the so-called “softest” segment is termed the “first transition temperature”, also referred to herein as the “activation temperature”. It is important to note that if the SMP has multiple segments characterized by the same thermal transition temperature, which is also the last transition temperature, then the SMP is said to have multiple hard segments.

When the SMP is heated above the last transition temperature, the SMP material can be imparted a permanent shape. A permanent shape for the SMP can be set or memorized by subsequently cooling the SMP below that temperature. As used herein, the terms “original shape”, “previously defined shape”, and “permanent shape” are synonymous and are intended to be used interchangeably. A temporary shape can be set by heating the material to a temperature higher than a thermal transition temperature of any soft segment yet below the last transition temperature, applying an external stress or load to deform the SMP, and then cooling below the particular thermal transition temperature of the soft segment while maintaining the deforming external stress or load.

The permanent shape can be recovered by heating the material, with the stress or load removed, above the particular thermal transition temperature of the soft segment yet below the last transition temperature. Thus, it should be clear that by combining multiple soft segments it is possible to demonstrate multiple temporary shapes and with multiple hard segments it may be possible to demonstrate multiple permanent shapes. Similarly using a layered or composite approach, a combination of multiple SMPs will demonstrate transitions between multiple temporary and permanent shapes.

For SMPs with only two segments, the temporary shape of the shape memory polymer is set at the first transition temperature, followed by cooling of the SMP, while under load, to lock in the temporary shape. The temporary shape is maintained as long as the SMP remains below the first transition temperature. The permanent shape is regained when the SMP is once again brought above the first transition temperature with the load removed. Repeating the heating, shaping, and cooling steps can repeatedly reset the temporary shape.

Most SMPs exhibit a “one-way” effect, wherein the SMP exhibits one permanent shape. Upon heating the shape memory polymer above a soft segment thermal transition temperature without a stress or load, the permanent shape is achieved and the shape will not revert back to the temporary shape without the use of outside forces.

As an alternative, some shape memory polymer compositions can be prepared to exhibit a “two-way” effect, wherein the SMP exhibits two permanent shapes. These systems include at least two polymer components. For example, one component could be a first cross-linked polymer while the other component is a different cross-linked polymer. The components are combined by layer techniques, or are interpenetrating networks, wherein the two polymer components are cross-linked but not to each other. By changing the temperature, the shape memory polymer changes its shape in the direction of a first permanent shape or a second permanent shape. Each of the permanent shapes belongs to one component of the SMP. The temperature dependence of the overall shape is caused by the fact that the mechanical properties of one component (“component A”) are almost independent of the temperature in the temperature interval of interest. The mechanical properties of the other component (“component B”) are temperature dependent in the temperature interval of interest. In one embodiment, component B becomes stronger at low temperatures compared to component A, while component A is stronger at high temperatures and determines the actual shape. A two-way memory device can be prepared by setting the permanent shape of component A (“first permanent shape”), deforming the device into the permanent shape of component B (“second permanent shape”), and fixing the permanent shape of component B while applying a stress.

It should be recognized by one of ordinary skill in the art that it is possible to configure SMPs in many different forms and shapes. Engineering the composition and structure of the polymer itself can allow for the choice of a particular temperature for a desired application. For example, depending on the particular application, the last transition temperature may be about 0° C. to about 300° C. or above. A temperature for shape recovery (i.e., a soft segment thermal transition temperature) may be greater than or equal to about −30° C. Another temperature for shape recovery may be greater than or equal to about 40° C. Another temperature for shape recovery may be greater than or equal to about 100° C. Another temperature for shape recovery may be less than or equal to about 250° C. Yet another temperature for shape recovery may be less than or equal to about 200° C. Finally, another temperature for shape recovery may be less than or equal to about 150° C.

Optionally, the SMP can be selected to provide stress-induced yielding, which may be used directly (i.e. without heating the SMP above its thermal transition temperature to ‘soften’ it) to make it conform to a given surface. The maximum strain that the SMP can withstand in this case can, in some embodiments, be comparable to the case when the SMP is deformed above its thermal transition temperature.

Although reference has been, and will further be, made to thermoresponsive SMPs, those skilled in the art in view of this disclosure will recognize that photoresponsive SMP's, moisture-responsive SMPs and SMPs activated by other methods may readily be used in addition to or substituted in place of thermoresponsive SMPs. For example, instead of using heat, a temporary shape may be set in a photoresponsive SMP by irradiating the photoresponsive SMP with light of a specific wavelength (while under load) effective to form specific crosslinks and then discontinuing the irradiation while still under load. To return to the original shape, the photoresponsive SMP may be irradiated with light of the same or a different specific wavelength (with the load removed) effective to cleave the specific crosslinks. Similarly, a temporary shape can be set in a moisture-responsive SMP by exposing specific functional groups or moieties to moisture (e.g., humidity, water, water vapor, or the like) effective to absorb a specific amount of moisture, applying a load or stress to the moisture-responsive SMP, and then removing the specific amount of moisture while still under load. To return to the original shape, the moisture-responsive SMP may be exposed to moisture (with the load removed).

Suitable shape memory polymers, regardless of the particular type of SMP, can be thermoplastics, thermosets-thermoplastic copolymers, interpenetrating networks, semi-interpenetrating networks, or mixed networks. The SMP “units” or “segments” can be a single polymer or a blend of polymers. The polymers can be linear or branched elastomers with side chains or dendritic structural elements. Suitable polymer components to form a shape memory polymer include, but are not limited to, polyphosphazenes, poly(vinyl alcohols), polyamides, polyimides, polyester amides, poly(amino acid)s, polyanhydrides, polycarbonates, polyacrylates, polyalkylenes, polyacrylamides, polyalkylene glycols, polyalkylene oxides, polyalkylene terephthalates, polyorthoesters, polyvinyl ethers, polyvinyl esters, polyvinyl halides, polyesters, polylactides, polyglycolides, polysiloxanes, polyurethanes, polyethers, polyether amides, polyether esters, and copolymers thereof. Examples of suitable polyacrylates include poly(methyl methacrylate), poly(ethyl methacrylate), poly(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate) and poly(octadecylacrylate). Examples of other suitable polymers include polystyrene, polypropylene, polyvinyl phenol, polyvinylpyrrolidone, chlorinated polybutylene, poly(octadecyl vinyl ether), poly(ethylene vinyl acetate), polyethylene, polyethylene oxide)-poly(ethylene terephthalate), polyethylene/nylon (graft copolymer), polycaprolactones-polyamide (block copolymer), poly(caprolactone)diniethacrylate-n-butyl acrylate, poly(norbornyl-polyhedral oligomeric silsequioxane), polyvinylchloride, urethane/butadiene copolymers, polyurethane-containing block copolymers, styrene-butadiene block copolymers, and the like. The polymer(s) used to form the various segments in the SMPs described above are either commercially available or can be synthesized using routine chemistry. Those of skill in the art can readily prepare the polymers using known chemistry and processing techniques without undue experimentation.

As will be appreciated by those skilled in the art, conducting polymerization of different segments using a blowing agent can form a shape memory polymer foam, for example, as may be desired for some applications. The blowing agent can be of the decomposition type (evolves a gas upon chemical decomposition) or an evaporation type (which vaporizes without chemical reaction). Exemplary blowing agents of the decomposition type include, but are not intended to be limited to, sodium bicarbonate, azide compounds, ammonium carbonate, ammonium nitrite, light metals which evolve hydrogen upon reaction with water, azodicarbonamide, N,N′ dinitrosopentamethylenetetramine, and the like. Exemplary blowing agents of the evaporation type include, but are not intended to be limited to, trichloromonofluoromethane, trichlorotrifluoroethane, methylene chloride, compressed nitrogen, and the like.

Shape memory alloys are well-known in the art. Shape memory alloys are alloy compositions with at least two different temperature-dependent phases. The most commonly utilized of these phases are the so-called martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as the austenite start temperature (Aₛ). The temperature at which this phenomenon is complete is called the austenite finish temperature (A_{f}). When the shape memory alloy is in the austenite phase and is cooled, it begins to change into the martensite phase, and the temperature at which this phenomenon starts is referred to as the martensite start temperature (Mₛ). The temperature at which austenite finishes transforming to martensite is called the martensite finish temperature (M_{f}). It should be noted that the above-mentioned transition temperatures are functions of the stress experienced by the SMA sample. Specifically, these temperatures increase with increasing stress. In view of the foregoing properties, deformation of the shape memory alloy is preferably at or below the austenite transition temperature (at or below Aₛ). Subsequent heating above the austenite transition temperature causes the deformed shape memory material sample to revert back to its permanent shape. Thus, a suitable activation signal for use with shape memory alloys is a thermal activation signal having a magnitude that is sufficient to cause transformations between the martensite and austenite phases.

The temperature at which the shape memory alloy remembers its high temperature form when heated can be adjusted by slight changes in the composition of the alloy and through thermo-mechanical processing. In nickel-titanium shape memory alloys, for example, it can be changed from above about 100° C. to below about −100° C. The shape recovery process can occur over a range of just a few degrees or exhibit a more gradual recovery. The start or finish of the transformation can be controlled to within a degree or two depending on the desired application and alloy composition. The mechanical properties of the shape memory alloy vary greatly over the temperature range spanning their transformation, typically providing shape memory effect, superelastic effect, and high damping capacity. For example, in the martensite phase a lower elastic modulus than in the austenite phase is observed. Shape memory alloys in the martensite phase can undergo large deformations by realigning the crystal structure arrangement with the applied stress, e.g., pressure from a matching pressure foot. The material will retain this shape after the stress is removed.

Suitable shape memory alloy materials for fabricating the conformable shape memory article(s) described herein include, but are not intended to be limited to, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and the like. The alloys can be binary, ternary, or any higher order. Selection of a suitable shape memory alloy composition depends on the temperature range where the component will operate.

The articles of the exemplary embodiments described herein may be used in various applications, including but not limited to shims and washers, door jams, and any of a variety of adjustable hold devices which reposition and/or reconfigure for use.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application. The terms “front”, “back”, “bottom”, “top”, “first”, “second”, “third” are used herein merely for convenience of description, and are not limited to any one position or spatial orientation or priority or order of occurrence, unless otherwise noted.

What is claimed is:

1. A method of adjusting the shape of a shape memory article comprising a plurality of shape memory polymer segments having different activation temperatures; the method comprising:
heating the article to a temperature greater than the activation temperature of at least one of the plurality of shape memory polymer segments and less than the activation temperature of at least one other of the plurality of shape memory polymer segments;
applying a compressive force to deform the heated shape memory polymer to a desired level of deformation; and
cooling the article to set the shape memory polymer at the desired level of deformation.

2. The article of claim 1, wherein a first shape memory polymer segment has a lowest activation temperature of said plurality of shape memory polymer segments, and each successive adjacent shape segment has a progressively higher activation temperature.

3. The method of claim 1, further comprising continuing to increase the temperature of the article above the activation temperature of one or more additional shape memory polymer segments while applying the compressive force until the predetermined level of deformation is reached.

4. The method of claim 2, further comprising continuing to increase the temperature of the article above the activation temperature of at least one of said successive shape memory polymer segments while applying the compressive force until the predetermined level of deformation is reached.

5. The method of claim 1, further comprising removing the compressive force after setting the shape memory polymer at the desired level of deformation.

6. The method of claim 1, further comprising, after cooling the article, removing or reducing the compressive force and heating the article to a temperature greater than the activation temperature of at least one of the plurality of shape memory polymer segments and less than the temperature of at least one other of the plurality of shape memory polymer segments to produce a second, reduced desired level of deformation or to return the article to its original shape, and then cooling the article to set the shape memory polymer.

7. The method of claim 6, further comprising applying a force urging the article toward its original shape, said force urging the article toward its original shape being applied by an elastically deformable member that was deformed during application of the compressive force.

8. The method of claim 1, further comprising, after cooling the article, applying compressive force and heating the article to a temperature greater than the activation temperature of at least one of the plurality of shape memory polymer segments and less than the temperature of at least one other of the plurality of shape memory polymer segments to produce a second, increased desired level of deformation, and then cooling the article to set the shape memory polymer.

9. The method of claim 1, wherein the compressive force is applied by activating one or more shape memory alloy elements connecting mounting members connected to opposite sides of said plurality of shape memory polymer segments, said mounting members being movable with respect to one another along a directional path between the mounting members through said plurality of shape memory polymer segments.

10. A method of adjusting the shape of a shape memory article comprising a shape memory polymer having a differential between T_{S} and T_{F} of at least 10° C. and no more than 70° C.; the method comprising:
heating the shape memory polymer to an activation temperature T_{S} and continuing to heat the shape memory polymer, thereby progressively raising the temperature in the range between T_{S} and T_{F} and progressively reducing the stiffness of the shape memory polymer over a period of time, while applying compressive force to deform the heated shape memory polymer to a desired level of deformation; and
cooling the article to set the shape memory polymer at the desired level of deformation.

11. The method of claim 10, further comprising removing the compressive force after setting the shape memory polymer at the desired level of deformation.

12. The method of claim 10, further comprising, after cooling the article, removing or reducing the compressive force and heating the shape memory polymer to an activation temperature T_{S} and continuing to heat the shape memory polymer, thereby progressively raising the temperature in the range between T_{S} and T_{F} and progressively reducing the stiffness of the shape memory polymer over a period of time, to produce a second, reduced desired level of deformation or to return the article to its original shape, and then cooling the article to set the shape memory polymer.

13. The method of claim 12, further comprising applying a force urging the article toward its original shape, said force urging the article toward its original shape being applied by an elastically deformable member that was deformed during application of the compressive force.

14. The method of claim 10, further comprising, after cooling the article, applying compressive force and heating the shape memory polymer to an activation temperature T_{S} and continuing to heat the shape memory polymer, thereby progressively raising the temperature in the range between T_{S} and T_{F} and progressively reducing the stiffness of the shape memory polymer over a period of time, to produce a second, increased desired level of deformation, and then cooling the article to set the shape memory polymer.

15. The method of claim 10, wherein the compressive force is applied by activating one or more shape memory alloy elements connecting mounting members connected to opposite sides of said plurality of shape memory polymer segments, said mounting members being movable with respect to one another along a directional path between the mounting members through laid plurality of shape memory polymer segments.

16. A controllably deformable shape memory article, comprising:
a first shape memory element comprising a shape memory polymer disposed between and directly or indirectly connected to a first mounting member and second mounting member, said first and second mounting members being movable with respect to one another along a directional path extending between the first and second mounting members through the first shape memory element; and
at least one second shape memory element comprising a shape memory alloy having first and second remembered shapes or lengths activated by temperature change and disposed between and directly or indirectly connected to the first and second mounting members.

17. The article of claim 16, further comprising an elastically deformable member mounted, disposed between and directly or indirectly connecting the first and second mounting members or disposed between and directly or indirectly connecting one of the first and second mounting members to a third member, said elastically deformable member urging the first and second mounting members away from one another.

18. A method of using the article of claim 16, comprising heating the shape memory polymer to reduce its modulus, and applying a thermal signal to the second shape memory element to cause it to actuate from a first remembered shape or length to a second remembered shape or length, thereby moving the first and second mounting members toward each other and compressing the shape memory polymer in the first shape memory element, and cooling the shape memory polymer to set the relative positions of the first and second mounting members.

19. The method of claim 18, further comprising, after cooling the shape memory polymer, heating the shape memory polymer to reduce its modulus, and applying a thermal signal to the second shape memory element to cause it to actuate from the second remembered shape or length to the first remembered shape or length, thereby allowing the first and second mounting members to move away from each other toward their original positions, and then cooling the shape memory polymer to set the relative positions of the first and second mounting members.

20. A controllably deformable shape memory article, comprising:
a first shape memory element comprising a plurality of shape memory polymer segments having different activation temperatures disposed between and directly or indirectly connected to a first mounting member and second mounting member, said first and second mounting members being movable with respect to one another along a directional path extending between the first and second mounting members through the first shape memory element; and
a load member capable of providing a force urging the first and second mounting members toward each other.
